(19) United States
(12) Patent Application Publication
(10) Pub. No.: US 2023/0337572 A1
(43) Pub. Date: Oct. 26, 2023

(54) Self-Loading Manure Spreader

(71) Applicant: Samuel S Brandenberger, Flemingsburg, KY (US)

(72) Inventor: Samuel S Brandenberger, Flemingsburg, KY (US)

(21) Appl. No.: 18/137,433

(22) Filed: Apr. 20, 2023

Related U.S. Application Data
(60) Provisional application No. 63/372,985, filed on Apr. 20, 2022.

(51) Int. Cl. A01C 3/08; A01C 3/06

(52) U.S. Cl. CPC A01C 3/08; A01C 3/066

(57) ABSTRACT

A self-loading manure spreader is claimed which possesses a scraper blade affixed to the front end of the spreader hopper so that as the front end is lowered the scraper blade scoops manure into the hopper as the spreader is pulled forward across a manure supply. The hopper floor is the carrying surface of a conveyor belt which is loaded as the scraper blade scoops up manure. The loading is further assisted by a continuously looping sweeper blade line which clears the top surface of the scraper blade by pushing or sweeping accumulated manure into the hopper. The manure is conveyed to the rear of the spreader where it is broken up by a clod breaker and then propelled into a deflector to increase the distribution width.

### CROSS REFERENCE TO RELATED APPLICATIONS

This Application claims priority from US Provisional Patent Application 70/372,985 filed on Apr. 20, 2022.

### TECHNICAL FIELD

The field of technology generally relates to methods for loading manure into a manure spreader.

### BACKGROUND

A manure spreader is a farm equipment designed to distribute animal waste, or manure, evenly over fields to fertilize the soil. The purpose of a manure spreader is to help farmers manage animal waste by using it as a nutrient-rich fertilizer that can enhance crop growth and yield.

The manure spreader typically has a large capacity hopper that holds the manure and a mechanism that breaks up and spreads the manure as it moves along. This mechanism is commonly driven by the tractor which is pulling the spreader, or powered by a separate engine.

Using a manure spreader facilitates the even distribution of manure across fields, which can also help to reduce the risk of nutrient runoff and soil erosion. Additionally, spreading manure on fields can help to reduce the need for chemical fertilizers, thereby lowering costs and improving soil health.

Manure contains various nutrients, including nitrogen, phosphorus, and potassium, that are essential for plant growth. When manure is applied to soil, these nutrients are gradually released into the soil, providing a slow and steady supply of nutrients to plants as they grow.

Nitrogen is an essential nutrient that plants need for growth and development because it is a key component of chlorophyll, which is a green pigment found in the chloroplasts of plant cells and is responsible for absorbing light energy and converting it into chemical energy through the process of photosynthesis.

Manure contains nitrogen in various forms, including ammonia, urea, and organic nitrogen. Nitrogen is also necessary for the synthesis of amino acids, which are the building blocks of proteins. Proteins are essential for the development and growth of new plant cells, and they are also involved in various metabolic processes within the plant. Additionally, nitrogen is a key component of nucleic acids, which are the genetic material of the plant.

When manure is applied to soil, nitrogen in the manure is converted into nitrates through a process called nitrification. These nitrates can be easily taken up by plants through their roots, providing the nitrogen that is needed for growth. Nitrification is a natural process that occurs in soil, whereby certain bacteria convert ammonium (NH₄⁺) into nitrite (NO₂⁻) and then into nitrate (NO₃⁻), which is the primary form of nitrogen that plants can absorb from soil and utilize for growth.

The nitrification process begins when certain bacteria in the soil called Nitrosomonas convert ammonium into nitrite. This process requires oxygen, and the nitrite produced is further converted into nitrate by another group of bacteria called Nitrobacter. These bacteria also require oxygen to carry out their function.

The nitrate produced through nitrification is highly soluble in water and can be easily taken up by the roots of plants. Nitrate is an essential nutrient for plant growth and development, and it is required in large amounts for crop production. Nitrates are readily soluble in water and can be easily transported through the plant’s vascular system to various parts of the plant where they are needed. Without a sufficient supply of nitrates, plants may exhibit stunted growth, yellowing of leaves, and reduced yield.

Phosphorus is another essential nutrient that is present in manure. Plants require phosphorus for the development of healthy roots and flowers, and to promote seed production. Manure contains phosphorus in organic and inorganic forms, and it is gradually released into the soil as manure decomposes.

Phosphorus is an essential nutrient needed by plants for growth and development. It plays a vital role in many physiological processes, including photosynthesis, respiration, energy transfer, and cell division.

One of the primary functions of phosphorus is in the formation of the nucleic acids DNA and RNA, which are the genetic material of the plant. Phosphorus is also required for the synthesis of ATP (adenosine triphosphate). ATP provides energy for cellular processes, including protein synthesis and cell division.

Phosphorus is also important for the growth and development of healthy roots. It helps to stimulate root growth and development, which allows the plant to absorb water and nutrients more effectively. Additionally, phosphorus helps to improve the overall health and vigor of the plant, making it more resistant to pests and diseases. When plants are grown in soil that is deficient in phosphorus, they may exhibit stunted growth, poor root development, and reduced yield.

Phosphorus is typically found in soil organic matter, plant residues, and manure in an insoluble form, which means it cannot be taken up by plants until it is converted into a soluble form. This process is called mineralization, and it is carried out by soil microorganisms such as bacteria and fungi. Mineralization is a natural process that occurs in soil, whereby organic phosphorus compounds are converted into phosphorus ions (PO₄³⁻) that can be readily taken up and utilized by plants. Mineralization provides a slow and steady supply of available phosphorus throughout the growing season. It is particularly important in soils that are low in available phosphorus, as it helps to maintain soil fertility and improve crop yields.

Therefore, it is important to ensure that plants have access to sufficient phosphorus through the use of fertilizers or soil amendments. However, excessive use of phosphorus can also have negative environmental impacts, such as eutrophication of water bodies, so it is important to use phosphorus fertilizers judiciously, taking into consideration the nutrient requirements of the crop and the health of the soil and surrounding ecosystem.

Potassium is the third essential nutrient present in manure. It plays a vital role in plant growth and development, promoting root growth and improving resistance to pests and diseases. Manure contains potassium in organic and inorganic forms, and it is slowly released into the soil as manure decomposes.

Potassium is an essential nutrient required by plants for growth and development. It plays a crucial role in various physiological processes, including photosynthesis, respiration, water regulation, and protein synthesis.

One of the primary functions of potassium is in the regulation of water balance within the plant. Potassium ions (K+) are involved in the movement of water through plant cells and tissues, helping to regulate the opening and closing of stomata (pores on the surface of leaves) and reducing the risk of water stress.

Potassium is also important for the regulation of plant growth and development. It helps to stimulate root growth, promote strong stem development, and improve overall plant vigor. Additionally, potassium plays a role in the synthesis of proteins, which are required for the growth and development of new plant cells.

Potassium is also involved in the process of photosynthesis, where it helps to regulate the opening and closing of stomata and the movement of CO₂ into and out of the plant cells. This helps to improve the efficiency of photosynthesis and promote healthy plant growth.

Moreover, potassium helps to improve the plant’s resistance to pests and diseases, by regulating the production of certain plant hormones and enzymes. It also helps to improve the plant’s tolerance to environmental stresses, such as drought and high temperatures. Manure is an ideal fertilizer because it is a natural waste material found in abundance on many farms and is an effective fertilizer for plants in that it provides a slow and steady release of essential nutrients that plants need for healthy growth and development.

Farmers typically use a variety of methods and equipment to load manure into a manure spreader’s hopper. The hopper is the storage area of the spreader where the manure is stored before it is spread onto a field. It is commonplace to shovel manure into the hopper of a manure spreader, but it is a time-consuming process which is physically demanding over the course of a workday because manure spreaders typically must be loaded several times to effectively supplement the soil in a single acre of agricultural soil. Moreover, the strenuous physical work of loading the hopper several times per acre increases the risk of physical injuries as well as heat-related injuries. Manually loading a manure spreader using shovels also consumes a considerable amount of time.

Another common method of loading a manure spreader involves filling the hopper using a front-end loader, which is a type of tractor attachment that has a bucket which can be raised, lowered, and rotated which allows it to scoop up the manure, carry it to the manure spreader, and deposit it in the hopper. One drawback to this method is the cost of fuel and oil, as well as the cost of purchasing and maintaining the equipment. Loading a manure spreader with a front-end loader can also consume valuable time, albeit less time than shoveling.

Yet another method for loading manure onto a spreader involves using a conveyor system. In this setup, a conveyor belt is used to move manure from the storage area to the spreader. The conveyor belt is typically powered by a motor and can be adjusted to control the speed of the manure delivery.

### BRIEF SUMMARY

This application describes various embodiments of a self-loading manure spreader. Self-loading manure spreaders are designed to be efficient and easy to use, reducing the need for manual labor and increasing the speed and accuracy of the spreading process. They are often used in larger agricultural operations where large amounts of manure need to be spread over a wide area and can help to improve soil fertility and crop yields.

In summary, the self-loading manure spreader described and claimed herein consists of a hopper having a scraper on its proximal end that can be lowered and raised which scrapes or shovels manure into the hopper as it is pulled across a manure supply. The scraper generally is in the form of a flat metal blade attached to a horizontal bar or frame. As the scraper is lowered, it is driven forward into the manure which accumulates on the scraper. A series of interconnected sweeper bars are proximally driven in a continuous loop to descend to the upper surface of the scraper blade and act to distally sweep the manure on the scraper blade into the hopper as each sweeper bar encounters the scraper blade. As each sweeper bar loops distally and then ascends to the top of the sweeper system, it acts to push the accumulated manure in the hopper distally to facilitate filling the distal end of the hopper.

The hopper floor is a continuous loop conveyor having a cleated conveyor belt which travels beneath the hopper and ascends towards the back of the spreader where the manure clods are broken up and distributed from the rear of the spreader.

The conveyor belt may be driven by the turning of the spreader’s wheels and actively engaged and disengaged as needed. The self-loading manure spreader is typically pulled by a tractor or large farm animal. As it is pulled or driven through a manure supply, the bucket line is lowered which allows the buckets to scoop manure for transport back to the bin.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 is a rear-facing perspective view of an embodiment of the spreader described herein.

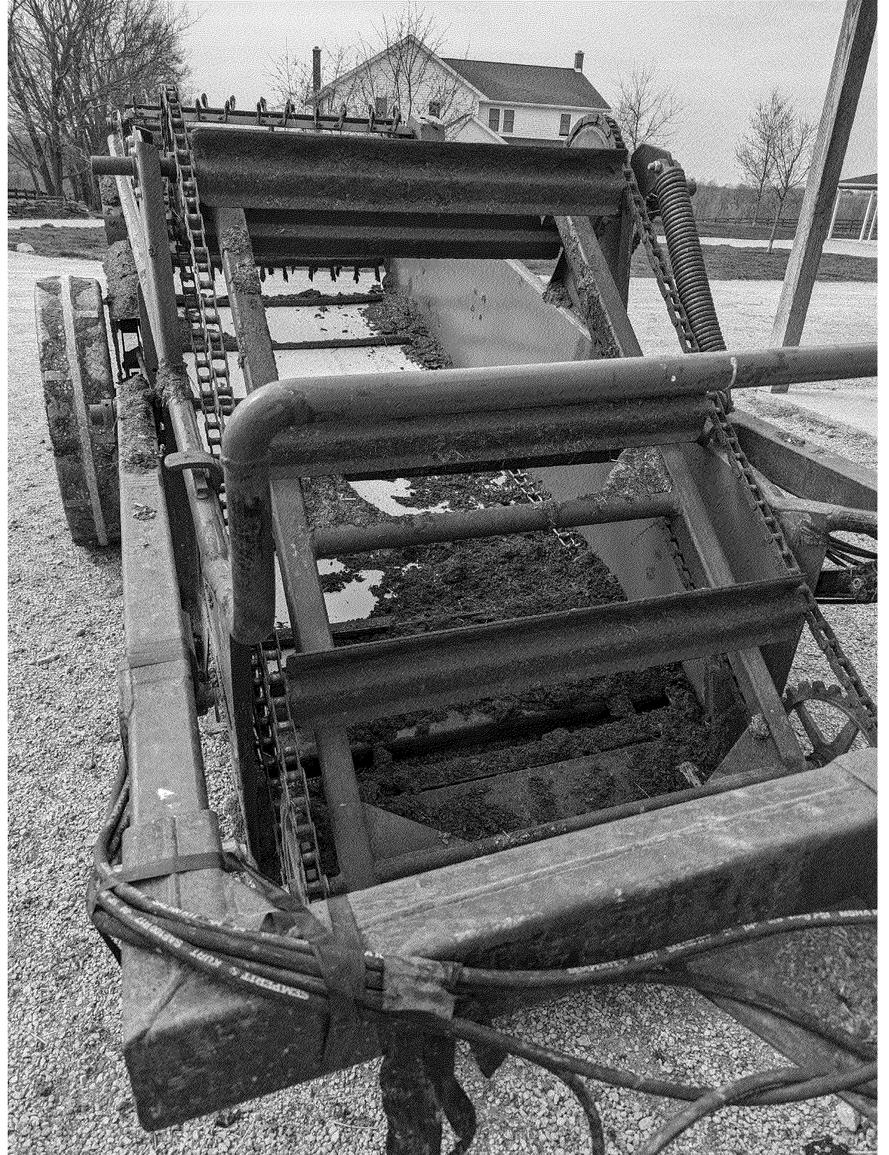

FIG. 2 is a side view of an embodiment of the spreader described herein which demonstrates the arrangement of the distally ascending conveyor system, sweeper blade line, clod buster, and scraper blade.

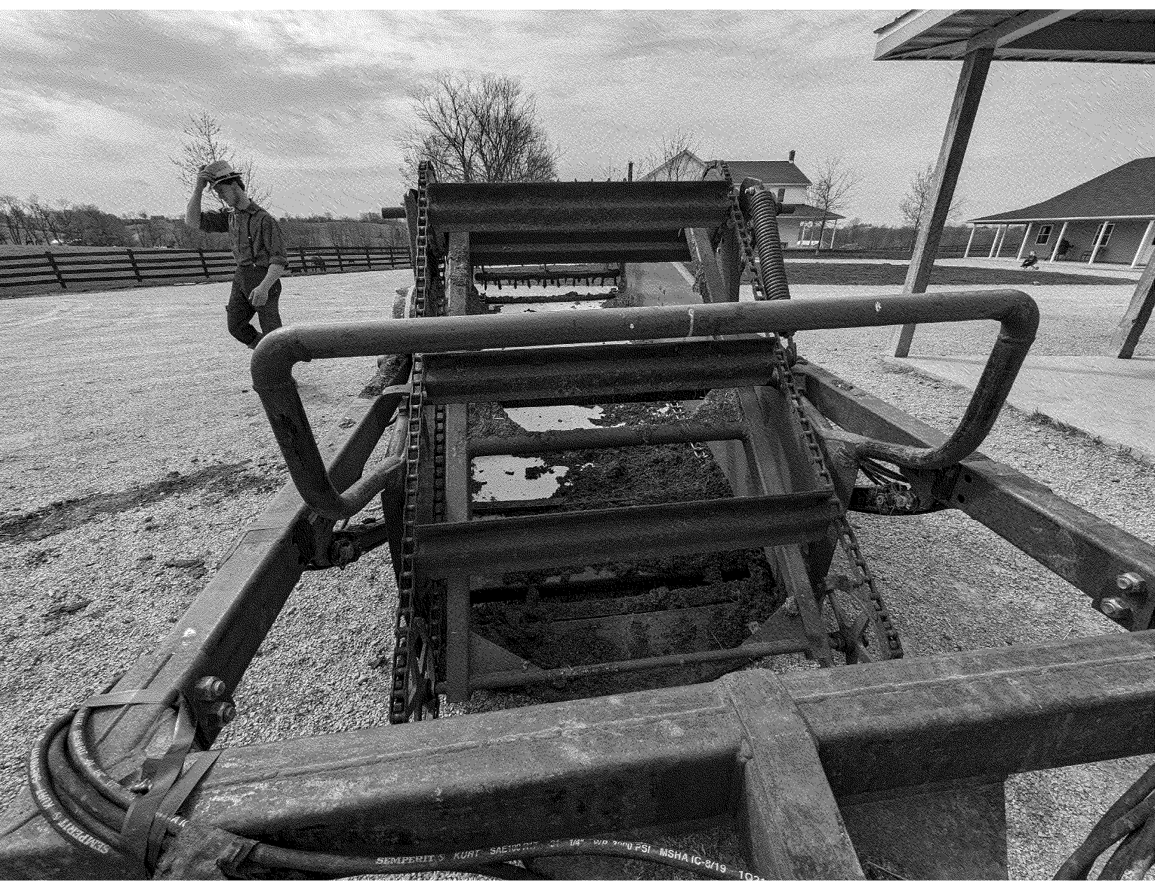

FIG. 3 is a top-plan view of an embodiment of the spreader described herein.

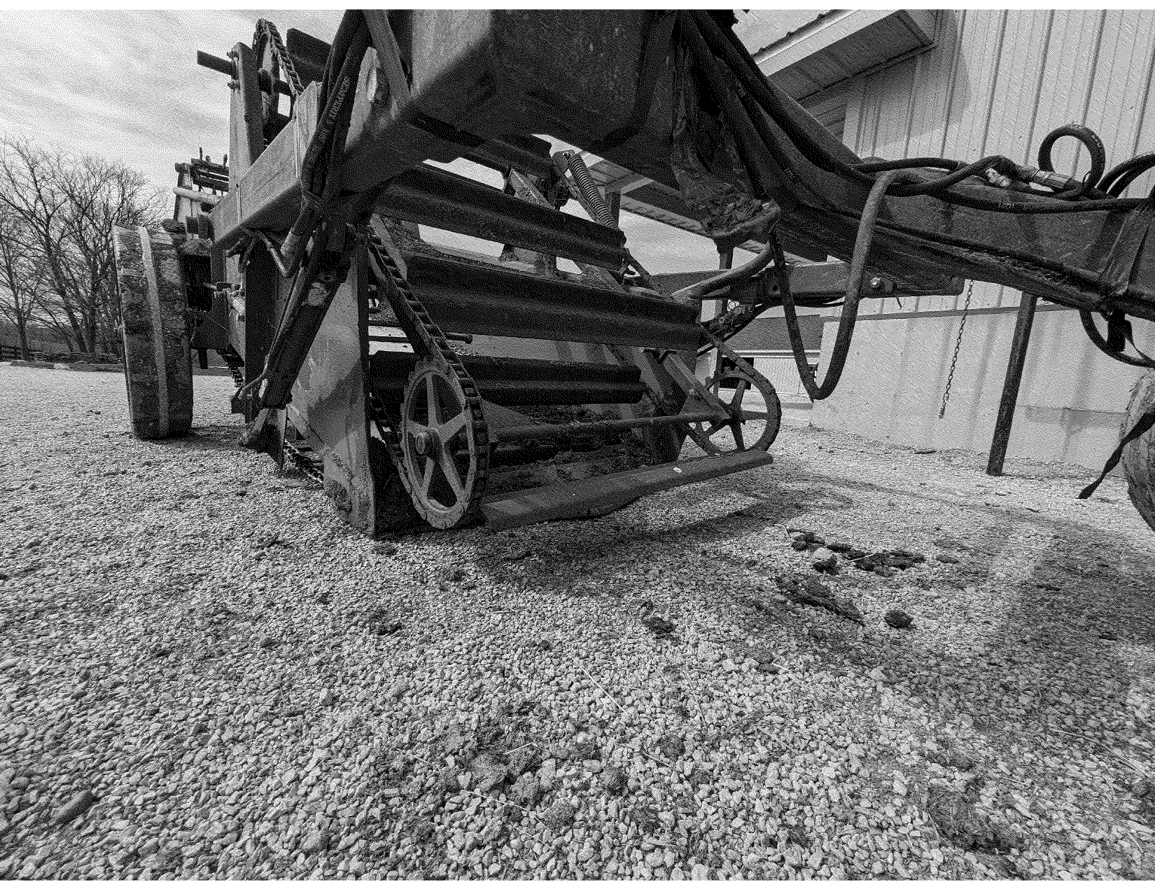

FIG. 4 is a partial perspective view of the proximal hopper end with affixed scraper blade and sweeper blade line of an embodiment of the spreader described herein.

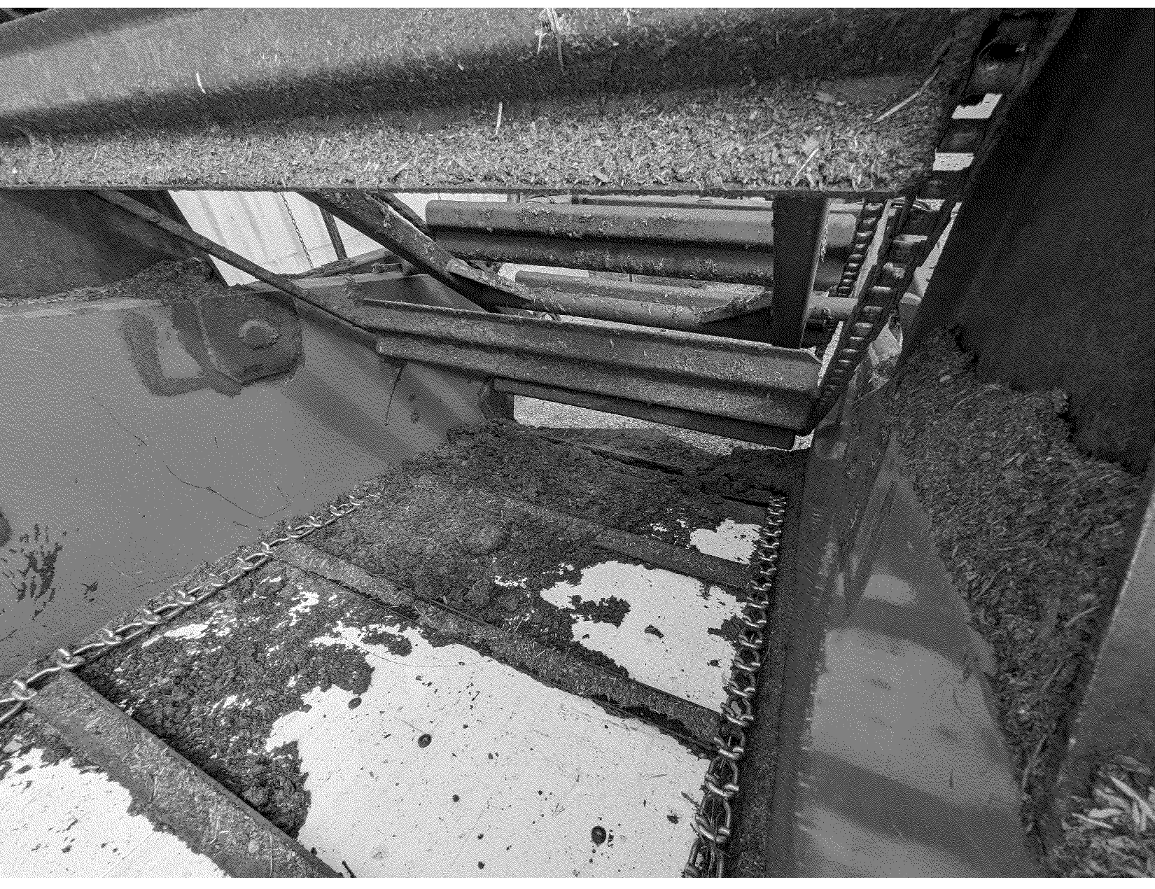

FIG. 5 is a partial perspective view of the clod busters of an embodiment of the spreader described herein.

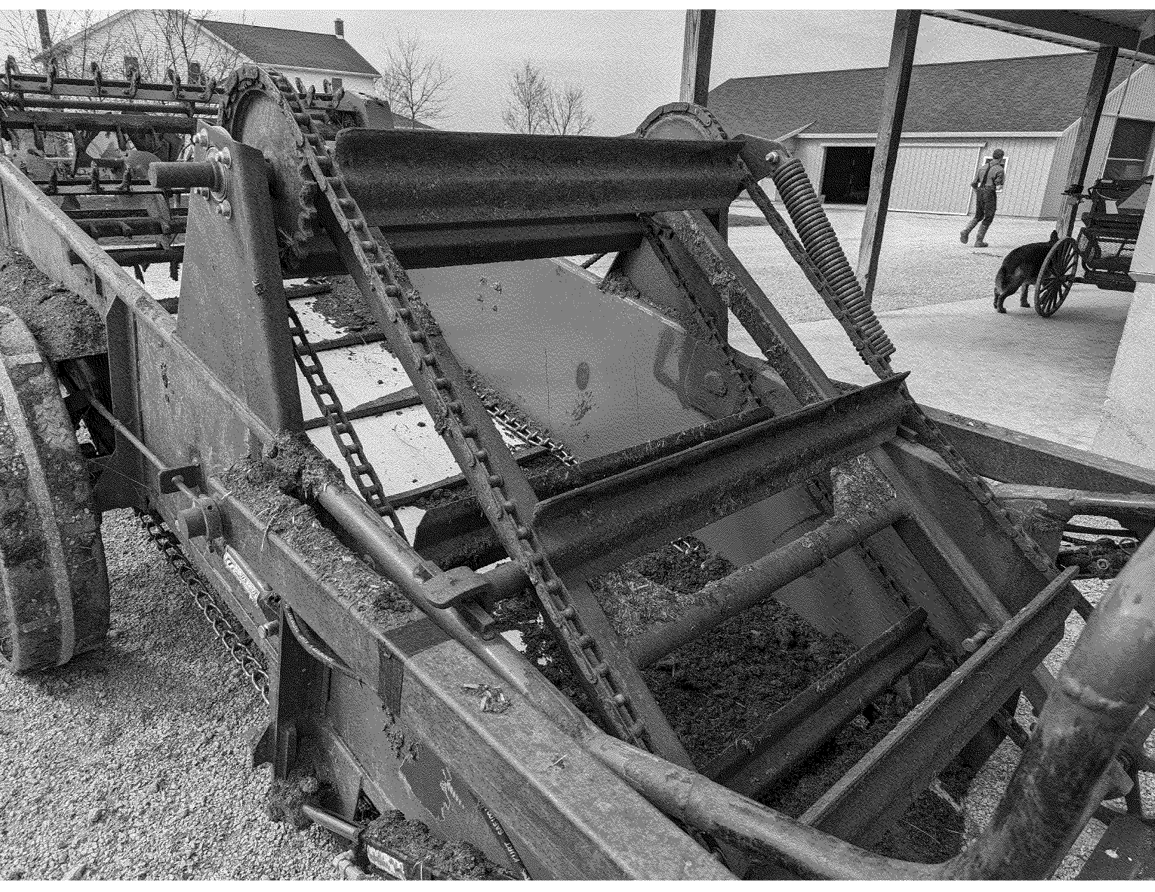

FIG. 6 is a perspective view of an embodiment of the spreader described herein used with a tractor.

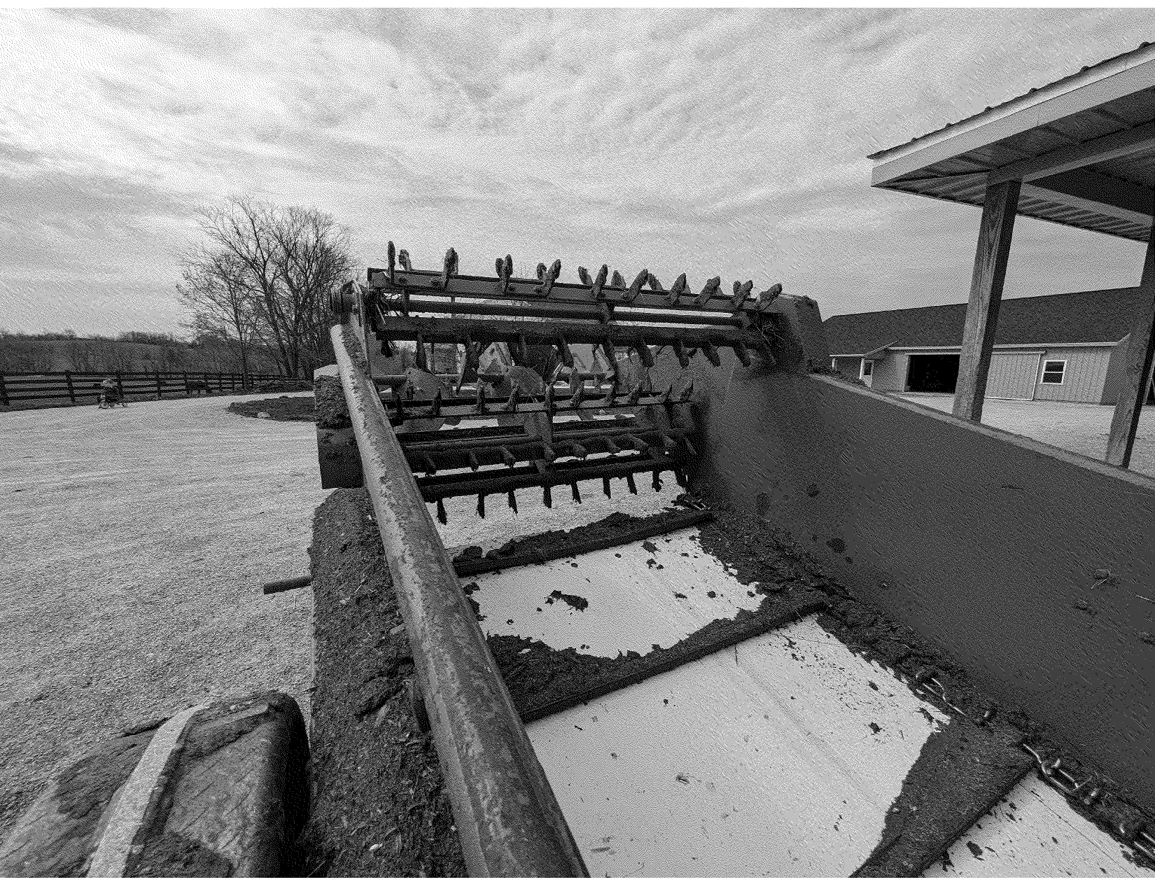

FIG. 7 is a partial top-plan view of the distribution pattern behind an embodiment of the spreader described herein.

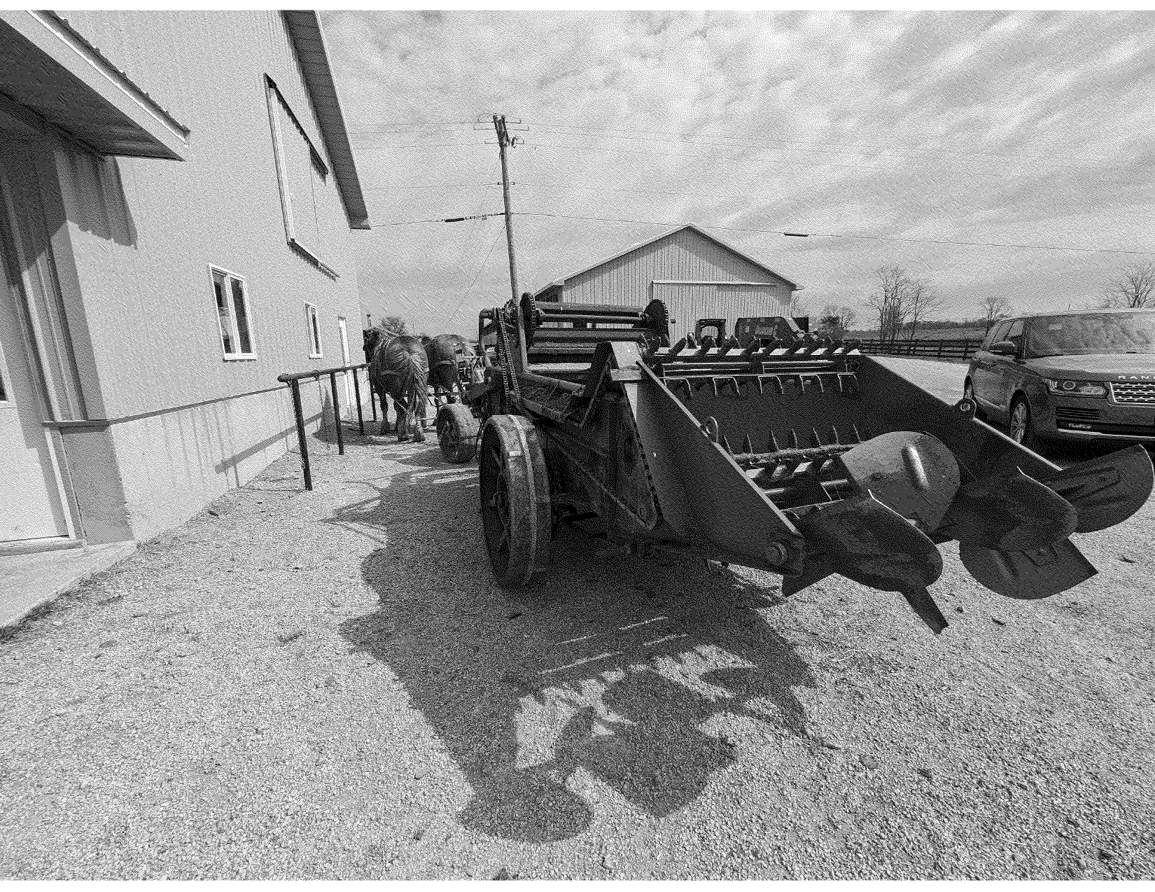

FIG. 8 is a partial perspective view of the proximal hopper end and scraper blade engaged in scooping manure during a loading event.

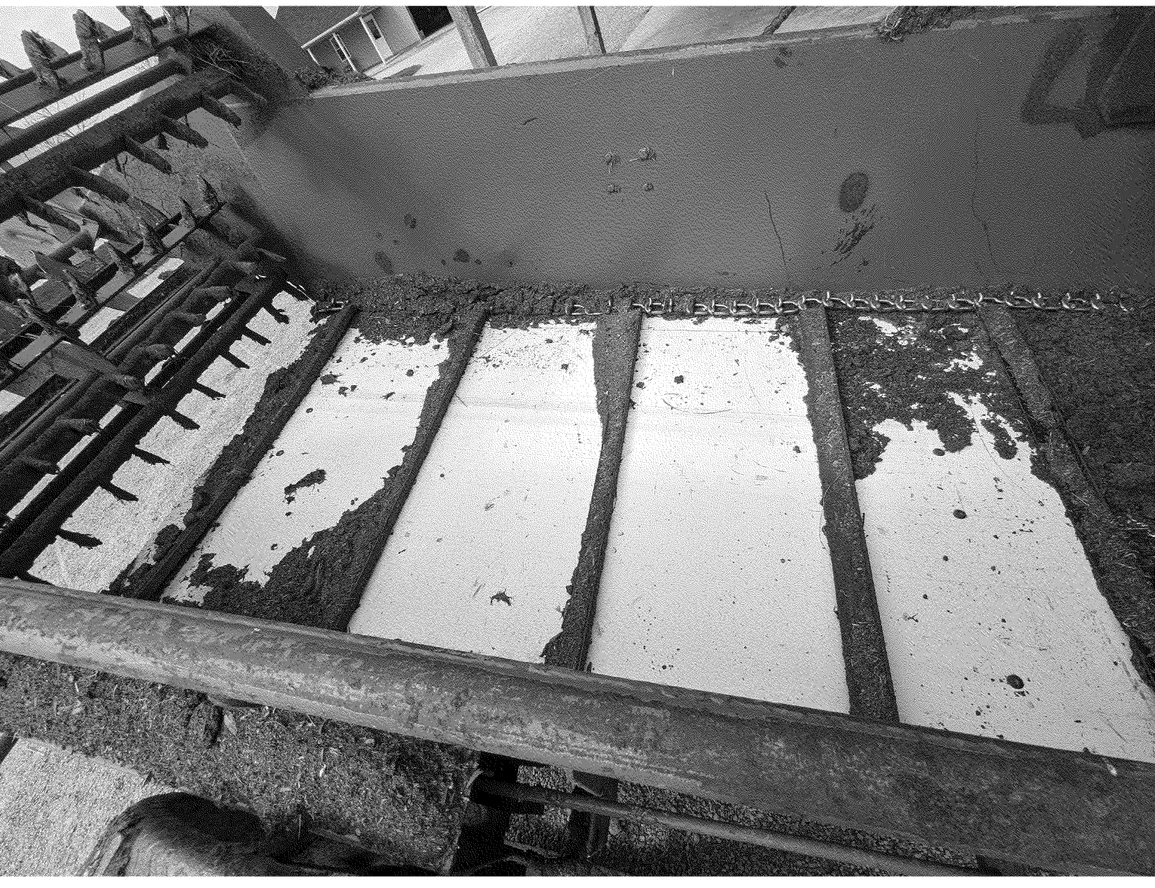

### DETAILED DESCRIPTION OF THE PREFERRED EMBODIMENTS

The present application is directed to a self-loading manure spreader 100. The spreader possesses a hopper 10 into which manure or other material is loaded for transport prior to spreading. For the sake of convenience, manure will be used with the understanding that other types of material may also be utilized. The hopper 10 possesses a hopper floor 20 and at least one lateral hopper wall 15 to retain manure deposited within the confines of the hopper 10. In a preferred embodiment, the hopper floor 20 is a continuous loop conveyor system 60 which utilizes a conveyor belt 70 to move manure from the proximal hopper end 12 to the distal hopper end 16.

In an embodiment, the conveyor belt 70 possesses cleats 75, e.g., raised ridges or other surface features. These cleats 75 act like small shelves or barriers that help to keep materials in place as they are transported by the looping conveyor belt 70. The size, shape, and spacing of the cleats can vary depending on the type of material being transported and the specific needs of the application. The conveyor belt carrying surface 73 receives and transports the manure loaded into the hopper 10 from the proximal hopper end 12 toward the distal hopper end 16. When the conveyor belt 70 loops around the distal conveyor end 67 at the distal hopper end 16, the carrying surface 73 is returned to the proximal hopper end 12 where it loops around the proximal conveyor end 63 beneath the scraper blade 30 to again function as the carrying surface 73.

The conveyor belt 70 loops continuously when actuated. In an embodiment, the conveyor belt 70 is driven by a conveyor drive chain 65 which can be engaged and disengaged on demand by coupling it to or decoupling it from a driven element 130, e.g. a spreader’s wheel 130 to name one exemplary embodiment. Additional types of driven elements include motors and tractor PTOs (“power take offs”). The speed of the conveyor belt 70 is regulated by controlling the speed of the driven element 130 which is optimally selected by the user to accomplish the specific task at hand.

The hopper 10 is loaded by lowering the proximal hopper end 12 to allow the scraper blade 30 to engage a manure supply over which the spreader 100 is pulled. The scraper blade 30 digs into the manure supply to scoop manure into the proximal hopper end 12 as the spreader 100 moves forward. A series of interconnected sweeper blades 45 on a continuous loop sweeper blade line 40 arranged at the proximal spreader end 115 provides assists in clearing the scraper blade 30 and moving the scooped manure distally into the hopper 10. The sweeper blades 45 are typically constructed with strong, durable materials, such as steel or reinforced plastic. As with the continuous loop conveyor system 60, the sweeper blade line 40 is continuously looped and is engaged and disengaged on demand by coupling it to or decoupling it from a driven element 130, e.g. a spreader’s wheel 130 to name one exemplary embodiment. The sweeper blades 45 descend as they travel to the proximal hopper end 12 where they scrape or sweep manure from the scraper blade 30 by proceeding distally toward the conveyor belt carrying surface 73 across the scraper blade top surface 33. The sweeper blades 45 ascend as the travel toward the distal hopper end 16 and further function to sweep deeper accumulations of manure towards the distal hopper end 16.

When the conveyor belt 60 is in operation, it ascends from the lowered proximal hopper end 12 towards the distal hopper end 16 to which it carries manure.

The distal spreader end 120 possesses a clod breaker 140 arranged at the distal hopper end 16 over the distal conveyor end 67 to break up clumps of manure to facilitate a more consistent distribution. A preferred embodiment of a clod breaker 140 consists of a series of rotating spikes or teeth that are mounted on at least one roller bar 144. The manure “clods” are broken up as the manure is propelled toward the distal spreader end 120. The conveyor belt 70 helps move the clods through the clod breaker 140 where it is propelled from the distal hopper end 12 to a series of deflectors which utilize the momentum of the manure pieces to scatter them in a pattern which is wider than the distal hopper end 16.

The conveyor belt 70 itself is flexible and typically made of a rubber or PVC material that is reinforced with fabric or steel cords for added strength and durability. The cleats 75 can be made of various materials, such as rubber or PVC, and are typically attached at regular intervals along the length of the conveyor belt 70.

As with the continuous loop conveyor system 60 and the sweeper blade line 40, the clod buster 140 is engaged and disengaged on demand by coupling it to or decoupling it from a driven element 130, e.g., a spreader’s wheel 130 to name one exemplary embodiment. In a further embodiment, the rotary speed of the clod buster 140 can be regulated and thus an optimized speed for the material being spread can be selected by the user. As examples, the clod buster 140 can also be driven by a motor or by a tractor PTO.

The embodiments described in this patent application are exemplary and not exclusive or limiting. It should be understood that one skilled in the art would be able to modify the disclosure in expected ways without departing from the spirit and scope of the invention. The various features and steps of the disclosed embodiments may be combined or altered in different ways to produce other embodiments that are within the scope of this invention. Therefore, the invention should be interpreted in light of the claims and the full scope of the disclosure, which should not be limited by the specific examples described herein.

What is claimed is:

1. A self-loading spreader comprising:
a. a mobile hopper having a proximal hopper end, a distal hopper end, at least one hopper side wall, and a means to lower and raise said proximal hopper end;
b. a scraper blade affixed to said proximal hopper end, said scraper blade having a top scraper blade surface;
c. a driven continuous loop conveyor system to transport the hopper contents from the proximal hopper end to the distal hopper end, wherein said continuous loop conveyor system possesses a conveyor belt which extends from immediately beneath said scraper blade to said distal hopper end;
d. a driven sweeper blade line having a plurality of continuously looping sweeper blades which sweeps material from said top scraper blade surface onto said conveyor belt;
e. a driven clod breaker arranged at said distal hopper end, said clod buster having at least one roller bar possessing a plurality of spikes; and
f. a material deflector which changes the trajectory of material discharged from the distal hopper end to create a wider distribution pattern.

2. The spreader of claim 1, wherein said conveyor system, said sweeper blade line, and said clod breaker are powered by a releasable connection to a wheel affixed to said mobile hopper.
